(19) United States
(12) Patent Application Publication
(10) Pub. No.: US 2017/0149326 A1
(43) Pub. Date: May 25, 2017

(54) CLAMPING CIRCUITRY

(71) Applicant: Functional Devices, Inc., Sharpsville, IN (US)

(72) Inventors: David L. Mackey, Rossville, IN (US); James R. Newton, Kokomo, IN (US); Matthew T. Long, Kokomo, IN (US)

(21) Appl. No.: 15/212,077

(22) Filed: Jul. 15, 2016

Related U.S. Application Data
(60) Provisional application No. 62/192,806, filed on Jul. 15, 2015.

(51) Int. Cl. H02M 1/32

(52) U.S. Cl. CPC H02M 1/32

(57) ABSTRACT

The present disclosure relates generally to a power source, a clamping device in electrical communication with the power source, wherein the clamping device is configured to redistribute a current generated by the power source, and a load in electrical communication with the clamping device and the power source.

### RELATED APPLICATION DATA

This application claims priority benefit of U.S. Provisional Application No. 62/192,806 filed Jul. 15, 2015, which is hereby incorporated in its entirety herein by reference.

### BACKGROUND

When a current source, such as a transformerless power supply, supplies current to an electronic or electrical circuit, current must be present at all times and distributed to various components of the circuit. If one or more components of the circuit are turned off while the current source is still supplying current, the remaining components of the circuit that are still on must accept the current that was being drawn by the now turned off components. The remaining components that are on must be rated to handle the sudden increase in current. Because there is a given resistance/impedance of the components that are still on, the power that must be dissipated by those components increases (i.e. IR loss). Generally, a heat sink must be added to the circuitry to dissipate the heat away from the components to maintain proper operation of the circuit. The additional heat sinks increase the size and cost of the circuitry.

Improvements are therefore needed in the art to reduce the need for heat sinks to dissipate heat within a circuit.

### SUMMARY OF THE DISCLOSURE

In accordance with an embodiment of the present disclosure, a clamping circuit is provided. The clamping circuit includes an electrical power source, a clamping device in electrical communication with the electrical power source, wherein the clamping device is configured to vary a current generated by the electrical power source to a portion of the clamping circuit, and a load in electrical communication with the electrical power source.

The electrical power source may be an alternating current power source. The electrical power source may be a direct current power source. The load may be configured to operate at a plurality of current amounts. The clamping device may redistribute the current generated by the electrical power source when the clamping device reduces its impedance and the load reduces a load current. The clamping device and the load may be in parallel. The clamping circuit may further comprise a clamping device control operably coupled to the clamping device, wherein the clamping device control may be configured to control the clamping device. The clamping device control may control the clamping device via at least one of an electrical and a mechanical operation.

In accordance with an additional embodiment of the present disclosure, a clamping circuit is provided. The clamping circuit includes an electrical power source, a load in electrical communication with the electrical power source and configured to operate at a plurality of current amounts, drive circuitry in electrical communication with the electrical power source, and a clamping device in electrical communication with the electrical power source and configured to vary a current generated by the electrical power source to the drive circuitry, wherein the clamping device is configured to redistribute a current generated by the electrical power source away from the drive circuitry when the clamping device reduces its impedance and the load reduces a load current.

The electrical power source may be an alternating current power source. The electrical power source may be a direct current power source. The clamping device and the load may be in parallel. The clamping circuit may further include a clamping device control operably coupled to the clamping device, wherein the clamping device control may be configured to control the clamping device. The clamping device control may control the clamping device via an electrical and/or a mechanical operation.

In accordance with an additional embodiment of the present disclosure, a transformerless power supply is provided. The transformerless power supply includes a clamping circuit. The clamping circuit includes an electrical power source, a clamping device in electrical communication with the electrical power source, wherein the clamping device is configured to vary a current generated by the electrical power source to a portion of the clamping circuit, and a load in electrical communication with the electrical power source.

The electrical power source may be an alternating current power source. The load may be configured to operate at a plurality of current amounts. The clamping device may redistribute the current generated by the electrical power source when the clamping device reduces its impedance and the load reduces a load current. The clamping device and the load may be in parallel. The transformerless power supply may further include a clamping device control operably coupled to the clamping device, wherein the clamping device control may be configured to control the clamping device.

### BRIEF DESCRIPTION OF THE DRAWINGS

FIG. 1 illustrates a clamping circuit in accordance with at least one embodiment of the present disclosure.

### DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

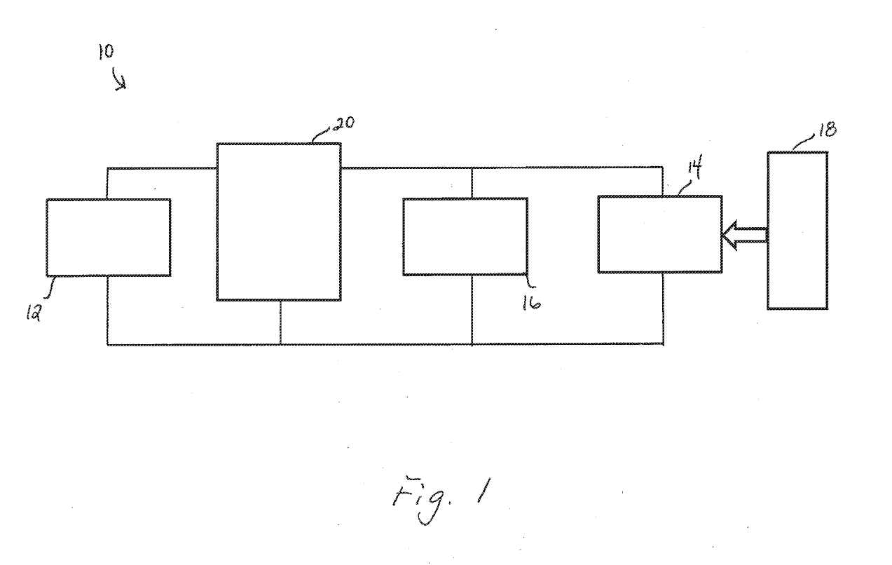

FIG. 1 shows a block diagram of a clamping circuit, generally indicated at 10. The clamping circuit 10 includes a power source 12 configured to supply power to a load 16. In an embodiment, the power source 12 includes a current source. It will be appreciated that the power source 12 may include a generator, a battery back-up power supply, or a transformerless power supply to name a few non-limiting examples. In an embodiment, power source 12 is an alternating current (AC) power source. In another embodiment, power source 12 is a direct current (DC) power source.

The clamping circuit 10 further includes a clamping device 14 in electrical communication with the power source 12. The clamping device 14 is configured to vary the current into the load 16. In another embodiment, the clamping device 14 is configured to alternate or adjust between an open state and a closed state or a relatively high impedance and a relatively low impedance. In one embodiment, when the clamping device 14 has a high impedance relative to an impedance in the load 16 and/or a circuit 20, the current flows normally through load 16 and the circuit 20. In another embodiment, when the clamping device 14 is in an open state, current flows normally through load 16 and the circuit 20. In another embodiment, when the clamping device 14 has a low impedance relative to an impedance in the load 16 and/or the circuit 20, the clamping device 14 bypasses the load 16, resulting in a reduced current for the load. The reduced current affects the performance of the load 16. In another embodiment, when the clamping device 14 is in the closed state, the clamping device 14 shunts, bypasses, or otherwise receives the current from the power source 12 resulting in the load 16 having substantially no current. The elimination current terminates the performance of the load 16.

In one or more embodiments of the present disclosure, with reference to one or more elements, functions, and features of the present disclosure, a high impedance includes, but is not limited to, an open or off state. Further, in one or more embodiments of the present disclosure, with reference to one or more elements, functions, and features of the present disclosure, a low impedance includes, but is not limited to, a closed or on state.

It will be appreciated that the clamping device 14 may include one or more components, such as a potentiometer, transistor, a switch, a solid state relay, an electromechanical relay, a triac, and/or an optoisolator to name a few non-limiting examples. It will further be appreciated that the clamping device 14 may either be powered or non-powered and may be internal or external to the clamping circuit 10. The circuit 20 includes one or more electronic components not forming part of the load 16 to be clamped. In one or more non-limiting examples, the circuit 20 includes drive circuitry for the load 16 such as one or more microcontrollers, communication components, integrated circuits, or transistors. In one non-limiting embodiment, the circuit 20 includes one or more diodes and/or resistors that would experience a significant decrease in temperature in the event that the load 16 has a reduced amount of current or is turned off and the clamping device 14 reduces its impedance.

The clamping circuit 10 further includes the load 16 in electrical communication with the clamping device 14 and the power source 12. The load 16 is configured to perform different functions based on variations in current in at least one embodiment. In another embodiment, the load 16 is configured to alternate between an on-state and an off-state in at least one embodiment. In another embodiment, the load 16 accepts current in one state and reduces or eliminates current flowing through itself in a second state. It will be appreciated that the load 16 may include one or more electronic components, such as a light, a motor, or a relay to name a few non-limiting examples.

In an embodiment, the clamping circuit 10 further includes a clamping device control 18 operably connected to the clamping device 14. The clamping device control 18 is configured to control or actuate the clamping device 14. Such control or actuation is performed by electrical, mechanical, and/or physical means in particular non-limiting examples.

In an example of operation of the clamping circuit 10, the power source 12 provides a current to the load 16 and at least a portion of the circuit 20. The circuit 20 in at least one embodiment remains in an on-state, even when the load 16 is in an off-state. Once the clamping device 14 is closed, the clamping device 14 shunts, bypasses or otherwise receives current from the power source 12 such that the load 16 receives less current. As such, in an embodiment, the load 16 is turned off because a controlled short is created by the clamping device 14 being in a closed state.

In at least one embodiment, when the clamping device 14 reduces its impedance, at least a portion of the circuit 20, and the load 16, receive varied amounts of current.

It will be appreciated that the clamping circuit 10 includes a clamping device 14 to effectively vary the current to any portion of a circuit powered by the power source 12 when the clamping device 14 has a relatively low impedance. Therefore, the clamping device 14 reduces IR loss and reduces or eliminates the need for heatsinks. In one non-limiting embodiment, the one or more diodes and/or resistors in the circuit 20, which would otherwise experience a significant increase in temperature in the event that the load 16 has a reduced amount of current, would not experience such an increase in temperature, and the need for a heat sink to remove heat from such components of the circuit 20 would be eliminated.

In at least one embodiment, clamping circuit 10 is deployed in a transformerless power supply.

Having shown and described particular embodiments of the disclosure, those skilled in the art will realize that many variations and modifications may be made to affect the described disclosure and still be within the scope of the claimed disclosure. Thus, many of the elements indicated above may be altered or replaced by different elements which will provide the same result and fall within the spirit of the claimed disclosure. It is the intention, therefore, to limit the disclosure only as indicated by the scope of the claims.

What is claimed is:

1. A clamping circuit comprising:
an electrical power source;
a clamping device in electrical communication with the electrical power source, wherein the clamping device is configured to vary a current generated by the electrical power source to a portion of the clamping circuit; and
a load in electrical communication with the electrical power source.

2. The clamping circuit of claim 1, wherein the electrical power source is an alternating current power source.

3. The clamping circuit of claim 1, wherein the electrical power source is a direct current power source.

4. The clamping circuit of claim 1, wherein the load is configured to operate at a plurality of current amounts.

5. The clamping circuit of claim 4, wherein the clamping device redistributes the current generated by the electrical power source when the clamping device reduces its impedance and the load reduces a load current.

6. The clamping circuit of claim 1, wherein the clamping device and the load are in parallel.

7. The clamping circuit of claim 1, further comprising a clamping device control operably coupled to the clamping device, wherein the clamping device control is configured to control the clamping device.

8. The clamping circuit of claim 7, wherein the clamping device control controls the clamping device via at least one of an electrical and a mechanical operation.

9. A clamping circuit comprising:
an electrical power source;
a load in electrical communication with the electrical power source and configured to operate at a plurality of current amounts;
drive circuitry in electrical communication with the electrical power source; and
a clamping device in electrical communication with the electrical power source and configured to vary a current generated by the electrical power source to the drive circuitry, wherein the clamping device is configured to redistribute a current generated by the electrical power source away from the drive circuitry when the clamping device reduces its impedance and the load reduces a load current.

10. The clamping circuit of claim 9, wherein the electrical power source is an alternating current power source.

11. The clamping circuit of claim 9, wherein the electrical power source is a direct current power source.

12. The clamping circuit of claim 9, wherein the clamping device and the load are in parallel.

13. The clamping circuit of claim 9, further comprising a clamping device control operably coupled to the clamping device, wherein the clamping device control is configured to control the clamping device.

14. The clamping circuit of claim 13, wherein the clamping device control controls the clamping device via at least one of an electrical and a mechanical operation.

15. A transformerless power supply comprising:
a clamping circuit, the clamping circuit comprising:
an electrical power source;
a clamping device in electrical communication with the electrical power source, wherein the clamping device is configured to vary a current generated by the electrical power source to a portion of the clamping circuit; and
a load in electrical communication with the electrical power source.

16. The transformerless power supply of claim 15, wherein the electrical power source is an alternating current power source.

17. The transformerless power supply of claim 15, wherein the electrical power source is a direct current power source.

18. The transformerless power supply of claim 15, wherein the load is configured to operate at a plurality of current amounts.

19. The transformerless power supply of claim 15, wherein the clamping device redistributes the current generated by the electrical power source when the clamping device reduces its impedance and the load reduces a load current.

20. The transformerless power supply of claim 15, wherein the clamping device and the load are in parallel.

21. The transformerless power supply of claim 15, further comprising a clamping device control operably coupled to the clamping device, wherein the clamping device control is configured to control the clamping device.
